(19) United States
(12) Patent Application Publication
(10) Pub. No.: US 2006/0062580 A1
(43) Pub. Date: Mar. 23, 2006

(54) Apparatus and method for transferring DC power and RF signals through a transparent or substantially transparent medium for antenna reception

(76) Inventor: Kamran Mahbobi, Closter, NJ (US)

Correspondence Address: KLAUBER & JACKSON, 411 HACKENSACK AVENUE, HACKENSACK, NJ, 07601, US

(21) Appl. No.: 10/947,042

(22) Filed: Sep. 22, 2004

(51) Int. Cl. H04B 10/00

(52) U.S. Cl. 398/116

(57) ABSTRACT

This invention relates generally to an specific embodiment of an interface for transmitting electrical power through a transparent or substantially transparent medium for use in an active antenna assembly used in vehicular satellite based communication, navigation or entertainment systems chosen from the group of applications consisting of SDARS, GPS, or other vehicular satellite services. A DC power and Radio Frequency wave coupling system is provided which employs RF and DC coupling across a transparent or substantially transparent medium. RF coupling is achieved using low cost and low loss RF coupler pairs such as quarterwave patches that are mounted opposite each other on either side of a transparent or substantially transparent medium. The feeds of the patches are aligned so as to be directly opposite each other, and the patches are mounted against the transparent or substantially transparent medium. A DC power transfer system allows DC power to be transferred across the insolated medium and be available for use by other electronic devices such as Low Noise Amplifiers. An alignment mechanism to facilitate the alignment of the power transfer module and RF coupler pairs.

### CROSS-REFERENCE TO RELATED APPLICATIONS

This application hereby incorporates in its entirety the application titled “Apparatus and Method for Transmitting Electrical Power Through a Transparent or Substantially Transparent Medium” (Inventor: Kamran Mahbobi), filed simultaneously with this present application on the day of Sep. 22, 2004.

### BACKGROUND OF THE INVENTION

This invention relates generally to a specific embodiment of power transfer interface for use in an active antenna assembly of vehicular based communication, navigation or entertainment satellite systems chosen from the group of applications comprising of SDARS, GPS, or other vehicular satellite services. The present invention provides for a DC power and Radio Frequency wave coupling system which offers RF and DC coupling across a transparent or substantially transparent medium. RF coupling is achieved in the present invention using low cost and low loss RF coupler pairs such as quarterwave patches that are mounted opposite each other on either side of the transparent or substantially transparent dielectric. The feeds of the patches in the present invention are aligned so as to be directly opposite each other, and the patches are mounted against the dielectric. The inventive DC power transfer system allows DC power to be transferred across the insolated medium and be available for use by other electronic devices such as Low Noise Amplifiers in an active antenna assembly. Applications of the inventive interface on such media might involve glass windows (such as in applications involving vehicles or standing structures where there is a need to drive power from inside through glass to antennae, intrusion detection sensors, etc.), where there is a need to avoid drilling or creating a hole through such glass.

Some prior art systems attempt to provide trans-glass signals and/or power for applications such as SDARS antennas or home satellite TV systems, but electrical power transfer for these applications is accomplished by use of a magnetic coupling. Magnetic couplings require that DC current be converted to an AC current that can excite a coil on one side of the medium, such that the current is then induced in a second coil on the other side of medium, and thereafter converted to DC current. However, these types of approaches do not provide for a versatile trans-glass power interface that provides for all manner of applications, such as mobile phone antennae, satellite or other video reception modalities, intrusion detection/security systems, or vehicular satellite radio systems. Moreover, the magnetic couplings themselves are cumbersome because the standard DC power utilized in such applications must be converted to AC power in order to affect power transfer in magnetic coupling. Additionally, the coils utilized in magnetic couplings must be aligned across the glass from each other in order to make the system function properly, something which is both time consuming and difficult to achieve when installing the interface. Power transfer through the use of magnetic coupling also requires the use of magnetic toroids that are typically circular in shape. This requirement constraints the shape of any magnetically coupled power transfer apparatus such that a suitable toroid can be accommodated. Moreover, there is a further problem associated with magnetic couplings because, in certain applications involving exposure to nearby electromagnetic interference (EMI), such as AM/FM broadcast signals from nearby receiving antennas, defrosting elements on car windows, etc., magnetic coupling can interfere with operations of AM/FM radios. Therefore, there is a need in the art for an interference resistant system that is versatile in terms of usage in diverse application, yet more easily installed within different electronic systems. Lastly, any apparatus that accomplishes the transfer of RF signals through a dielectric is highly susceptible to the alignment difficulties of the RF coupling pads, and the prior art systems make no attempt to provide any alignment feedback mechanism to address this issue.

### SUMMARY OF THE INVENTION

Certain electronics applications require the transfer of electrical power and radio signals across an electrically isolated and optically transparent medium such as glass without the use of electrical wires that require holes through the transparent medium. More specifically, this need is greatest in any through glass active antenna assembly used in vehicular satellite based communication, navigation or entertainment systems chosen from the group of applications comprising of SDARS, GPS, or other vehicular satellite services. The present invention provides a system that overcomes the deficiencies of prior art techniques for transmitting electrical signals through glass barriers in electronic circuits. Accordingly, the present invention provides an interference-resistant, versatile interface for transmitting electrical power between a first transmission line emanating from electronic circuitry that is connected to a conversion module on a first side of a substantially transparent medium (such as glass or other substantially transparent media), and a second transmission line that is connected to electronic circuitry on a second side of the substantially transparent medium. In direct contrast to the prior art interfaces that utilize magnetic coupling systems, the present invention accomplishes power transfer by using optical coupling in place of the magnetic couplings seen in prior art devices. Unlike magnetic coupling mechanisms, in the present invention there is no need for any DC to AC conversion on one side of the medium, and conversely, there is no need for a corresponding AC to DC conversion on the other side of the medium. DC electrical power is converted to optical power using any suitable source such as incandescent lights or fluorescent lights, lasers, laser diodes (LDs) or light emitting diodes (LEDs). The optical sources are arranged in an array to provide enough elimination for the receiving surface area. This optical power is passed through the transparent medium, and illuminates an array of solar cells which function as the receiving surface area on the other side of the medium. The array of solar cells converts the optical power to an equivalent DC current and voltage, the net result being the transfer of electrical power through the medium. Unlike magnetic coupling mechanisms, the shape of the power transfer interface is not dictated by the shape of its magnetic coil or toroid. The present invention could therefore take any shape, including long narrow strips. Moreover, in direct contrast to the prior art magnetic coupling systems, the power transfer surface in the present invention does not need to be contiguous, such that, several small surface area might even be utilized to achieve power transfer.

### BRIEF DESCRIPTION OF THE DRAWINGS

FIG. 1 is a generalized block diagram of the power transfer interface of the invention;

FIG. 2 is an offset view of the power transfer interface according to the invention for transmitting electrical power to an exterior transmission line, further detailing an exemplary patterning of the optical source and the receiving source;

FIG. 3 is a schematic diagram of circuitry according to the invention for an exemplary optical source, such as an IR LED array;

FIG. 4 graphically illustrates an exemplary receiving surface, such as a solar cell array arranged in parallel configuration;

FIG. 5 graphically illustrates an exemplary receiving surface, such as a solar array arranged in serial configuration;

FIG. 6 is a schematic diagram of alternative exemplary circuitry for a dual voltage array that may be configured within the present invention;

FIG. 7 is a 3-D view of an active through glass antenna (such as in a GPS or SDARS system) with an alignment module for alignment feed back;

FIG. 8 is a block diagram of an active through glass antenna assembly for a windshield;

FIG. 9 is a 3-D view of an through-glass active antenna assembly for a car windshield

FIG. 10 is a block diagram of an SDARS application utilizing the inventive interface; and

FIG. 11 is a 3-D diagram of an active through-glass complex in an SDARS application, with a separate active glass antenna.

### DETAILED DESCRIPTION

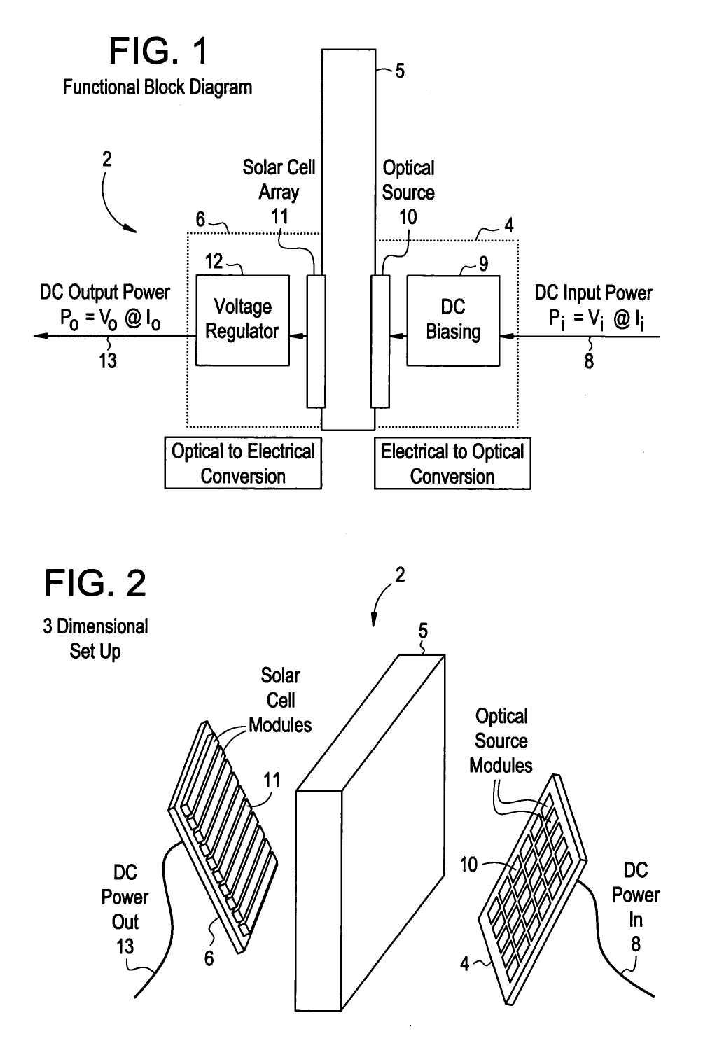

FIGS. 1 and 2 depict respectively, a functional block diagram, and 3-D offset exploded view of the power transfer part of the inventive interface. With ongoing reference to FIGS. 1 and 2, the inventive interface circuit 2 connects across a substantially transparent medium 5 (e.g., a dielectric such as glass), a first transmission line 8 delivering DC power from a first electronic circuit (not depicted) on a first side of the substantially transparent medium 5, and a second transmission line 13 that is connected to a second electronic circuit (not depicted) on a second side of the substantially transparent medium 5. In one embodiment, the interface 2 comprises an electrical to optical conversion module 4 at the first side for converting an electrical input received along the transmission line 8 from the first electronic circuit to an optical output. The electrical to optical conversion module 4 preferably includes a DC biasing unit 9 for inputting the DC input power into the optical source 10. The optical source 10 may be fabricated from several different optical sources, such as LEDs, LDs, lasers, infrared (IR) emitters, fluorescent or incandescent light sources (with the appropriate drivers), etc., as known in the art of emitting various forms of optical energy, and depending on specific needs such as cost, performance, size, etc. Selection of the particular wavelength to be utilized by the optical source is thereafter driven by the characteristic of the solar cell, as well as the transmission characteristic of the substantially transparent medium. As one skilled in the art will appreciate, the selection of the optical source also depends on the particulars regarding the end use or application of the interface, whether used on car, home or building windows, or in laboratory vacuum applications, etc.

Accordingly, the present invention contemplates all of the above variants as possible embodiments therein, however, depending on the target application, several key factors such as a desired power transfer efficiency, size, and cost may determine different embodiments. With regard to cost, sources with high electrical to optical efficiencies (such as lasers or LDs) are typically more expensive than more traditional optical sources such as incandescent or fluorescent lights. To this end, for less expensive applications one alternative embodiment might utilize incandescent and fluorescent light sources, despite the trade offs therein, in terms of the limited wavelength options and the relatively low electrical to optical conversion efficiency.

Given that the efficiency of the electrical to optical conversion further depends upon the optical wavelength used, a particularly efficient embodiment might utilize infrared or monochrome (e.g., single or narrowband wavelength) optical sources, rather than multi color optical sources which are not especially efficient for converting electrical power to optical power. To this end, in one embodiment, where cost is less of a concern than high power transfer efficiency, traditional lasers or semiconductor based laser diodes (LDs) would offer the highest optical power density, and hence the best electrical to optical conversion efficiencies of all possible optical sources, particularly given the variety of wavelengths such as IR available therein.

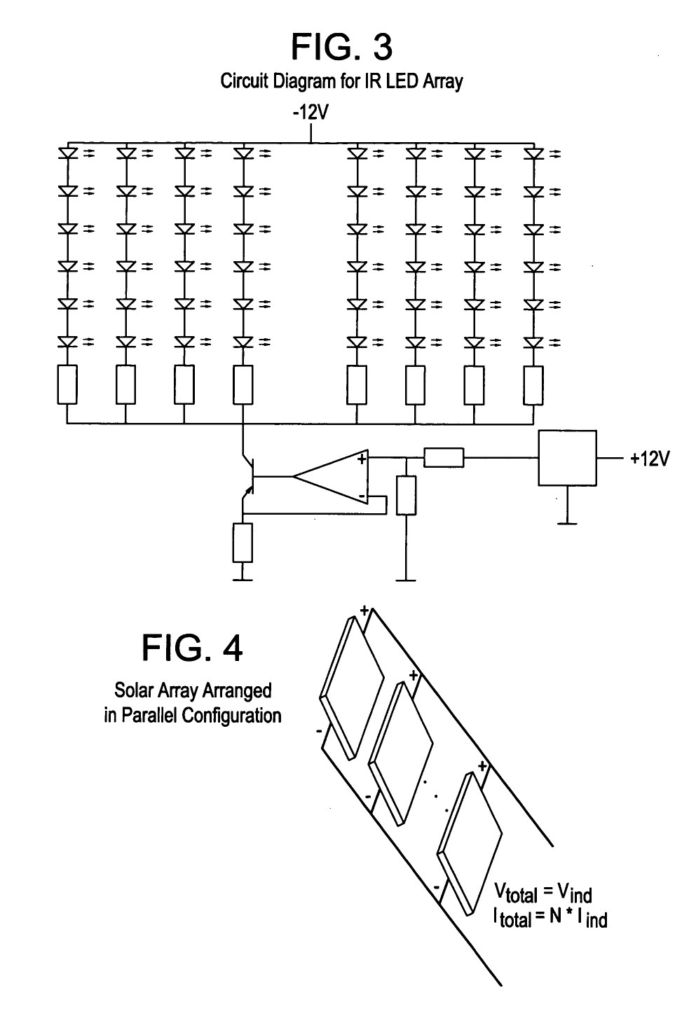

By way of illustration in one exemplary application of the inventive interface, automobile satellite radio systems, might preferably utilize LEDs as an optical source within the inventive interface, given their versatility and the above detailed trade off between power conversion efficiency, size, and cost of other optical sources. However, specialized LEDs (such as GaAs LEDs) might be favorably utilized because of their small size, variety of wavelengths (IR to UV), ease of array configuration, reliability, and efficiency. FIG. 3 depicts a typical circuit configuration for an exemplary IR LED array used on one side of a substantially transparent medium. The optical output of this embodiment is transmitted from the preferred optical source across the substantially transparent medium 5 from the first side of the substantially transparent medium 5 to the optical to electrical conversion module 6 at the second side of the substantially transparent medium 5. The optical to electrical conversion module 6 comprises a solar cell array 11 for receiving the optical output. The solar cell array comprises an array of individual solar cells that, when illuminated by an optical source, produce a voltage and a current based the photovoltaic effect, thereby converting the optical power to electrical power.

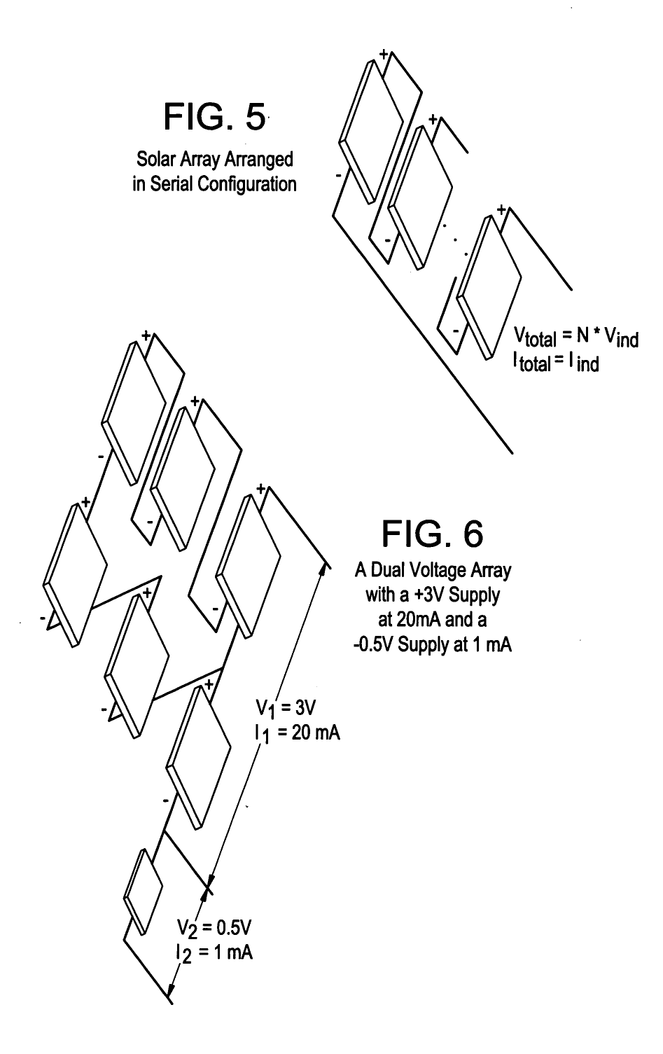

After an appropriate optical source is thusly selected to fit the application utilizing the described interface, the particular solar cell array 11 will be ideally matched so as to optionally cooperate with the chosen optical source. Commercially available solar cells come in a variety of sizes and efficiencies. The selection of a specific solar cell or solar cell technology depends on the desired conversion efficiency, size and cost constraints. Typically, a solar cell can deliver a fixed voltage (typically between 0.5V to 0.6V) and a variable current that is proportional to the surface area of the cell and optical illumination density. Solar cells are often characterized by their open circuit voltage and closed circuit current capability. Larger surface areas result in larger current generation capability of the solar module when it is fully illuminated by a sufficient optical source. Under a constant optical illumination, parallel configuring of N individual cells allows for producing constant voltage at N times the individual current capacity of each module as shown in FIG. 5. Alternatively, a serial connection of N solar cells as depicted in FIG. 6, allows for producing N times the voltage at the rated current of an individual solar cell. Accordingly, the electrical power generation capability of a solar array is directly proportional to the illuminated optical power density and the total array surface area. By arranging the individual cells in solar arrays, one can achieve a desired voltage and current to be delivered by the invention through the medium, as depicted in FIGS. 4, 5 and 6. A detailed discussion of a process to calculate the exact number of solar cells and diodes is also presented later in this document. Alternatively, one may further include a DC-DC power converter to convert the regulated output of the solar cell array to any desired voltage and current needed for output.

Although the figures herein depict a scenario where individual solar cells are of uniform size and surface area, it will be understood that the invention need not be limited in this regard, as different solar cell sizes can be used to precisely engineer an exact voltage and current deliver mechanism. Additionally, one embodiment provides for the use of a solar cell arrangement to produce multiple polarity voltages, an exemplary illustration of which is depicted in FIG. 6.

The type or composition of solar cells may thus be modified within the scope of the invention, depending on the needs of the user and the end application. By way of one further possible embodiment, single crystal silicon solar cells offer moderate efficiencies for low to medium optical illumination density at a lower cost. Moreover, mono crystalline cells are easy to manufacture and cut, and readily available at affordable prices. Silicon solar cells are designed for solar power generation with direct sun illumination and therefore can only handle typical optical power densities not exceeding 1-sun (100 mW/cm²). However, because the power conversion efficiency is also a function of wavelength of the optical source, silicon solar cells actually offer the highest efficiency in the IR wavelengths. Accordingly, in the exemplary scenario described above for the use of IR LED optical sources, it would then be optimal to choose a silicon solar cell array as described.

In alternative embodiments, usage of other suitable solar cell arrays might be contemplated. Where the particular application requires optimal performance despite a higher cost, it is possible to construct the solar cell array within more efficient single crystal silicon solar cells that can reach levels over 20% efficiency. The newest generation of such cells such as those offered by Sunpower Corp of Sunnyvale, Calif. offer the additional benefit of having a high closed circuit current capability. With the same surface area as conventional solar cells, these new solar cells can handle much higher optical power densities and generate much more current. These cells are designed for solar power generation with use of concentrating lenses for high intensity illumination and therefore can handle optical power density approaching 30 suns (3000 mW/cm²). A detailed discussion of a process to calculate the exact number of solar cells elements and their arrangement is also presented later in this document.

In particular, it is possible to increase optical to electrical conversion efficiencies of solar cells by using other semiconductor materials, such as Gallium Arsenide. Although GaAs based solar cells are expensive, the use of a solar array made of GaAs solar cells and an IR LED array also based on GaAs LEDs offers a very high efficiency power transfer for another embodiment within the scope of the present invention.

Regardless of the type of solar cell and optical source chosen, the voltage and current will be produced by the photovoltaic effect at the solar cell array 6, for normalization by voltage regulator 12. Once regulated, the electrical conversion module 6 has completely converted the optical output received to an electrical output in the form of a DC power output for transmission along second transmission line 13 to the second circuitry (not depicted). Such circuitry might optionally include an additional DC-DC converter to convert the regulated output voltage to any desired voltage required. In all of the above embodiments, where one varies the optical source and/or the type of solar cell array, the resulting current may be easily controlled without the addition of any further components. Of course, the relative efficiencies described above may be taken into account, given the circuit needs of either side of the substantially transparent medium 5. By way of one specific example of an application of the inventive interface, a conventional SDARS receiver used on board of a vehicle (car, truck, bus, aircraft, watercraft, etc.) requires an active antenna (typically a combination of a receive antenna, low noise amplifier and filter). The specially designed active antenna assembly requires a first stage LNA that operates at a voltage between 3-5V and a current of 10-20 mA. In a typical application, the user has to place the active antenna outside the vehicle for the antenna to have full visibility of the SDARS satellites. When provided in such a manner, the electrical power transmission according to the invention would meet the power requirements of the first stage LNA in this specially designed active SDARS antenna assembly. In such a case, the required DC power would be delivered through voltage regulator 12, which can provide a regulated 3 VDC output (or any other required voltage), and the requested SDARS signals through optional radio frequency (RF) pads described hereafter.

Regardless of the particular application, the exemplary parameters may be shown for determining the specifics pertaining to the size and numbers of solar cells in an array, and the power derived therefrom. For example, in a typical application where DC power transfer through a transparent medium can be achieved by the use of the invention, it is necessary to design the type, size and configuration of the electronics components necessary to achieve a required power transfer. Furthermore, in such a typical application, a certain amount of power (Pₒᵤₜ) is required at the second side of the substantially transparent medium. This power is typically consumed by electronic circuitry connected thereto (e.g., devices such as antennae) that operate at a required voltage (Vₒᵤₜ) and a load current (Iₒᵤₜ) where Pout=Vₒᵤₜ*Iₒᵤₜ. To achieve power delivery of Pₒᵤₜ, a solar cell configuration must be selected that can deliver Vₒᵤₜ and Iₒᵤₜ. As described above regarding FIGS. 4, 5 and 6, various parallel or series configurations of solar cells can be assembled to make this possible. On the first side of the substantially transparent medium, there must be enough optical power to illuminate the solar cells with sufficient intensity so that the power received at the second side can support the requirements of the particular electronic circuitry associated therewith. The relationship between the input power to the device (Pin) and Pₒᵤₜ may be described as:
Pₒᵤₜ=ηₛₒₗₐᵣ*η_{optical}*η_{medium}*Pᵢₙ where:
ηₛₒₗₐᵣ=Optical to electrical conversion efficiency of the solar array
η_{opticl}=Electrical to Optical conversion efficiency of the optical array (e.g., LEDs)
η_{medium}=Optical transmission efficiency factor for the medium (1=no transmission loss)

Given the required Pₒᵤₜ and the efficiencies of the components involved, one can then calculate the required Pᵢₙ. One can follow the same approach to size the optical source as well. If Pᵢₙ, is known, the total optical power required is P_{optical}=Pᵢₙ*η_{optical}. If a basic optical module (e.g., a discrete LED) has an optical intensity of Pₒ, then the number of optical modules (e.g., discrete LEDs) necessary is Pᵢₙ/P_{optical} rounded up to the nearest integer.

As an example for one application of the inventive interface designed and suitable for use in a through glass SDARS active antenna assembly, assume then that the power transfer requirements are Vₒᵤₜ=3V, iₒᵤₜ=10 mA (to successfully power the 1^{ST} LNA stage of a through glass active antenna assembly for SDARS) which requires a Pout of 30 mW.

If a 0.5×2.5 cm commercially available solar cell module is used for a smallest solar cell component (basic module), it can deliver 0.5V at 10 mA when properly illuminated and electrically loaded. Accordingly, one would use 6 of these basic modules in series to be able to make up the required 3V and 10 mA. This would equate to a surface area of 6 times the basic module or 7.5 square cm (approximately 1.1 sq inches). Thereafter, further assume:
ηₛₒₗₐᵣ=15%
η_{optical}=10% for an IR LED
η_{medium}=90%

The Pᵢₙ would be calculated as 2.2 W and P_{optical} as 0.22 W. Using a typical, commercially available IR diode with say, 5 mW of optical radiated power, a minimum of 44 diodes would then be necessary to illuminate the solar cell array. Therefore, for the given application in question, the diodes would be arranged to uniformly illuminate 1.1 square inches of the solar cell array. In an exemplary case, one might use a source such as TSFF5200 IR diodes available from Vishay Semiconductors of Heilbronn, Germany and in the solar cell array one might use solar cells such as IXOLAR™ Solar Cells available from IXYS Corporation of Santa Clara Calif. Accordingly, the power to the active antenna is thusly provided from the inside where the SDARS receiver resides to the outside of the vehicle by use of the inventive interface.

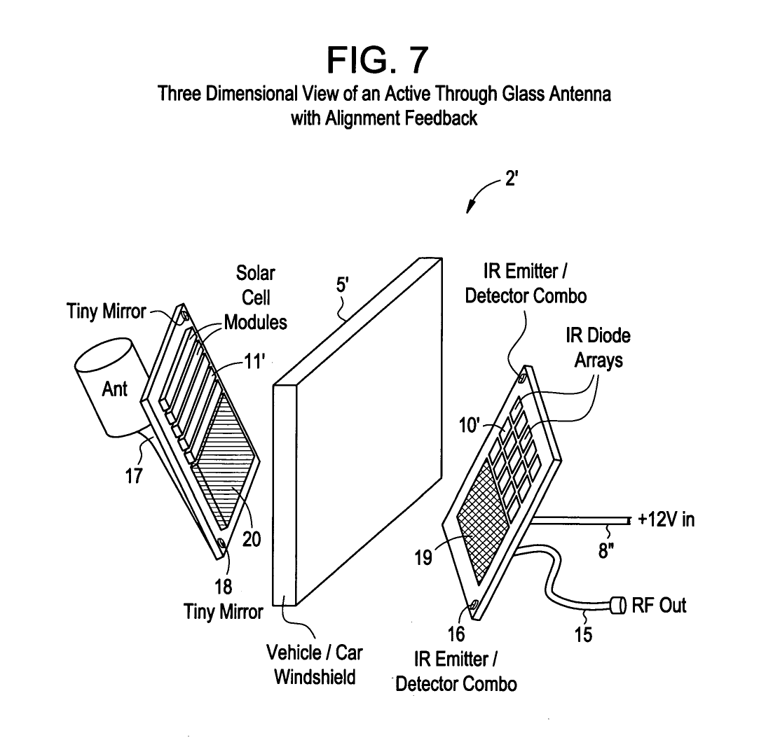

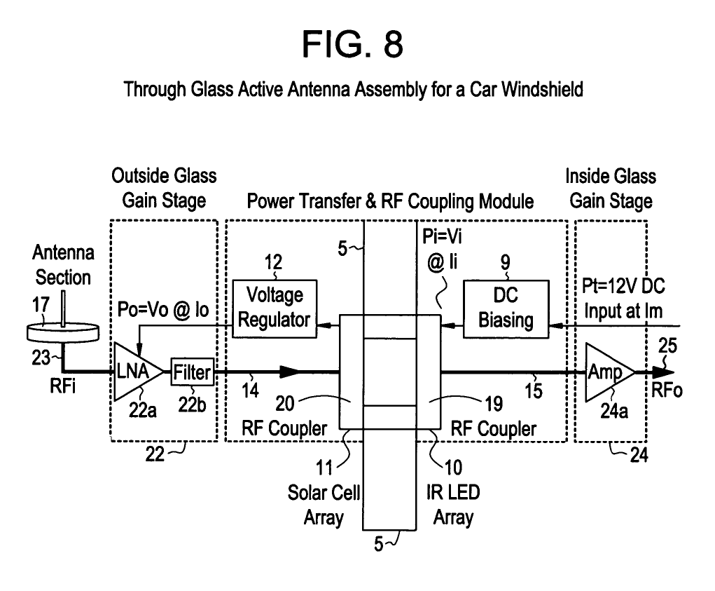

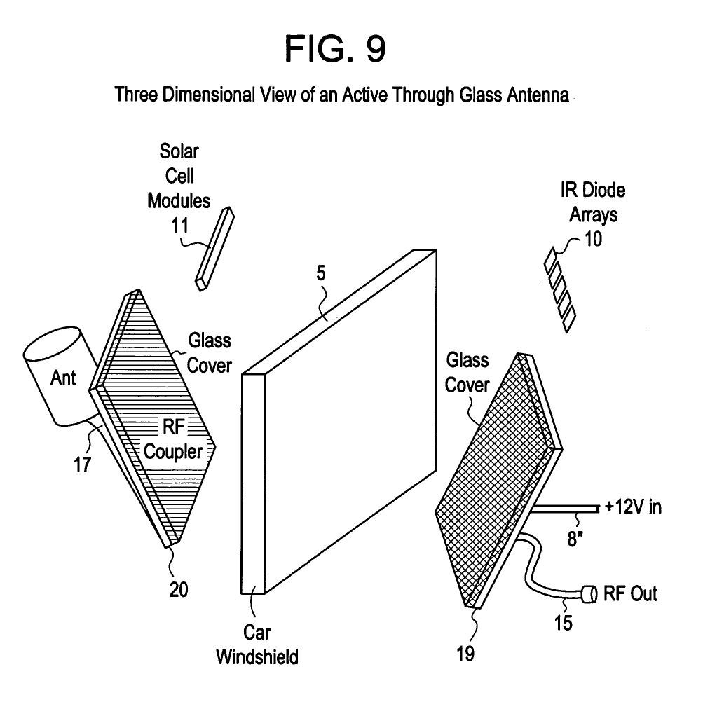

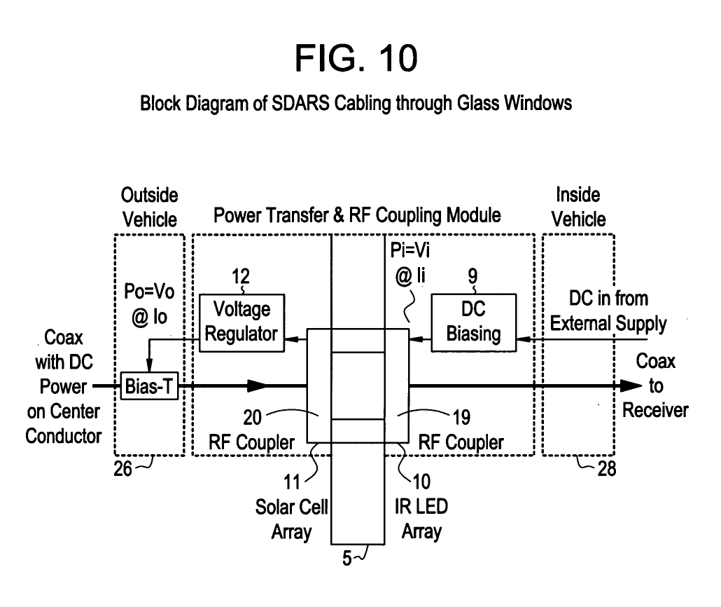

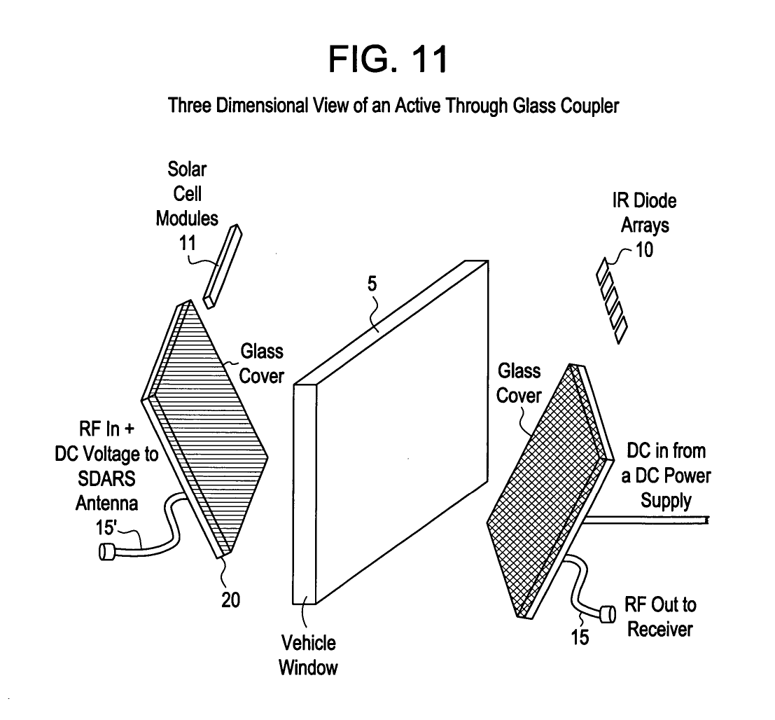

As mentioned above, RF signal transmission are also incorporated into the invention. Such transmission would be in association with (e.g., located functionally proximate to) the above described conversion modules, and would ideally be provided for through the use of RF pads, such as those disclosed in U.S. Pat. Nos. 5,929,718; 6,686,882; 6,446,263; and 5,612,652 all of which are hereby incorporated by reference in their entirety. FIG. 8 shows the functional block diagram for the embodiment of the invention in the form of an active through-glass antenna system used for GPS or SDARS vehicular applications. The antenna section consists of elements that are tuned for the target signal. As an example, SDARS antenna element will be capable of receiving S-band satellite and terrestrial signal at 2.3 GHZ frequencies. Once the signals are received, they are amplified using a Low Noise Amplifier (LNA) 22a. This amplifier is powered by a DC voltage provided by voltage regulator 12. The power transfer mechanism consists of an IR LED array that illuminates a matched solar cell array. Additional circuitry on both sides of the glass DC biasing for the LED array as well as voltage regulation for the Solar cell array. Signals amplified by the LNA 22a may typically go through a bandpass filter 22b. Cooperative RF pads are used for bidirectionally transmitting RF signals between said first side of said substantially transparent medium, to said second side of said substantially transparent medium, as depicted in the exemplary embodiment in FIGS. 7 and 9. As seen in FIG. 8, RF signal transmission circuitry may include an antenna 17 connected to the second RF pad 20 along an RF feed line 14 so as to transmit broadband RF to a first RF pad 19, whereby first RF pad 19 is receiving signals from the second RF pad 20 that originated from the electronic circuitry at the second side of the substantially transparent medium. Typically such electronic circuitry from the first side of the substantially transparent medium is situated inside a vehicle in the case of a GPS or SDARS as broadly referenced in FIGS. 10 and 11. Thus, the pairs of RF Pads are arranged to conduct the RF signals across the substantially transparent medium. Additional amplification is provided by amp 24a to balance for any losses through the glass RF coupling pads 20 and 19 such that the through glass arrangement becomes equivalent to its direct wired alternative. Main DC power is fed to the inside the windshield unit through a DC power cord. A typical 3 dimensional view of such a through glass antenna is depicted in FIG. 9.

As further depicted in FIG. 7, an optional alignment module comprising alignment circuitry may be provided for in substantial proximity to the RF plates 19, 20, and/or the optical source 10 (depicted as IR diode arrays 10′ in FIG. 7) and to solar cell array 11 (depicted as solar cell modules 11′ in FIG. 7). Such alignment circuitry might, in one exemplary embodiment, comprise at least one IR emitter/detector 6 on one side, and on the other side of the substantially transparent medium (depicted as a vehicle or car windshield 5′ in FIG. 7), at least one small mirror fixed in a location so as to be in axial alignment from IR emitter/detector 16 when there is substantial alignment between opposing RF pads 19, 20 and/or optical source 10 and solar cell array 11. This provides that when opposing RF pads 19, 20 and/or optical source 10 and solar cell array 11 are mounted on the surface of the substantially transparent medium 5, 5′, across from each other on their respective (inside/outside) sides of the substantially transparent medium 5, 5′, that they will be in substantial axial alignment so that any light or signal transmission (whether IR, or in other forms) can be efficiently and more fully transmitting and receiving the respective DC and/or RF energies. The feedback mechanism is also used by the electrical to optical module 4 containing optical source 10 to detect the substantially aligned presence of the optical to electrical module 6 containing the solar cell array 11. In a scenario where, say one module accidentally falls off, the electrical to optical module 4 containing the optical source 10 would immediately shut down (would permit no light or IR transmission from optical source 10) and a visual and audio alarm would bring it to the attention of the user. In addition to the safety benefits therein, the feedback mechanism of the alignment module also eliminates the necessity that the antenna installation be performed by trained professionals who can perform the accurate alignment. With the added feedback alignment, any antenna system using the inventive interface could even be installed using non-permanent glass mounts such as suction cups thereby eliminating the absolute necessity of utilizing permanent adhesions like seen in prior art alignments. Such a feature would be highly desirable in applications such as portable GPS navigation systems, where a portable GPS can now be used with a reusable through glass active antenna that uses the inventive process with alignment and a non-permanent mounting method. In alternate embodiments where a permanent mounting method for the inventive interface is used, caution must be taken that the bonding surfaces are coated with substantially transparent bonding agents as not to interfere with the transparency of the medium. Alternatively, a non-transparent bonding agent can be applied to the perimeter of the power transfer apparatus to achieve the same results. It is further noted, that depending on the system requirements, surface constraints (such as automobile heating elements and the like) one may configure both the optical source 10 and solar array 6 in many different shapes and sizes, so as to customize installation according to need.

It is to be understood that the invention is not limited to the illustrations described and shown herein, which are deemed to be more illustrative of the best modes of carrying out the invention, and which are susceptible of modification of form, size, and arrangement of parts and details operation. These modifications are within the spirit and scope of the appended claims.

What is claimed is:

1. An interface circuit for use in an active antenna assembly used in vehicular satellite based communication, navigation or entertainment systems, said interface circuit used for connection between a first transmission line that is connected to a first electronic circuit on a first side of a substantially transparent media and a second transmission line that is connected to a second electronic circuit on a second side of the substantially transparent media, comprising:
an electrical to optical conversion module at said first side for converting an electrical input received from said first electronic circuit through said first transmission line, to an optical output, said electrical to optical conversion module having an optical source therein for transmitting said optical output across said substantially transparent media from said first side of said substantially transparent media;
an optical to electrical conversion module at said second side for receiving said optical output, from said optical source of said electrical to optical conversion unit, and for converting said optical output received from said optical source to an electrical output, said optical to electrical conversion module having a receiving surface area for receiving said optical output from across said substantially transparent media.

2. The interface circuit for use in use in an active antenna assembly used in vehicular satellite based communication, navigation or entertainment systems of claim 1, wherein the optical source is a light source selected from the group consisting of LEDs, LDs, lasers, infrared, or visible light sources and is configured so as to be used in vehicular satellite based communication, navigation or entertainment systems chosen from the group of applications consisting of SDARS, GPS, or other vehicular satellite services.

3. The interface circuit for in an active antenna assembly used in vehicular satellite based communication, navigation or entertainment systems of claim 2 wherein said receiving surface area for receiving said optical output is a solar cell array in substantial alignment with said optical source, said solar cell array being selected from the group consisting of conventional silicon solar cell arrays, high efficiency solar cell arrays, and GaAs solar cell arrays.

4. The interface circuit for in an active antenna assembly used in vehicular satellite based communication, navigation or entertainment systems of claim 3, wherein the optical source comprises an IR LD, said solar cell array comprises conventional silicon solar cell arrays, and is configured so as to be used in an SDARS application.

5. The interface circuit for in an active antenna assembly used in vehicular satellite based communication, navigation or entertainment systems of claim 4, wherein said electrical input is DC power supplied thereto, and wherein said electrical to optical conversion module further includes a DC biasing circuit for converting the electrical input.

6. The interface circuit for in an active antenna assembly used in vehicular satellite based communication, navigation or entertainment systems of claim 5, further including a substantially proximate set of substantially aligned, cooperative RF pads for bidirectionally transmitting RF signals between said first side of said substantially transparent medium, to said second side of said substantially transparent medium.

7. The interface circuit for in an active antenna assembly used in vehicular satellite based communication, navigation, or entertainment systems of claim 6, where both the solar cell array and the optical source may be applied according to customized shapes and sizes.

8. The interface circuit for in an active antenna assembly used in vehicular satellite based communication, navigation or entertainment systems of claim 6, further including an alignment module.

9. A method for forming an interface circuit for in an active antenna assembly used in vehicular satellite based communication, navigation or entertainment systems for connection between a first transmission line that is connected to a first electronic circuit on a first side of a substantially transparent media and a second transmission line that is connected to a second electronic circuit on a second side of the substantially transparent media, consisting of the steps of:
connecting an electrical to optical conversion module to said first transmission line at said first side of said substantially transparent media, for converting an electrical input received from said first electronic circuit through said first transmission line, to an optical output, said electrical to optical conversion module being formed so as to have an optical source therein for transmitting said optical output across said substantially transparent media from said first side of said substantially transparent media;
connecting an optical to electrical conversion module to said second transmission line at said second side of said substantially transparent media, for receiving said optical output, from said optical source of said electrical to optical conversion unit, and for converting said optical output received from said optical source to an electrical output, said optical to electrical conversion module being formed so as to have a receiving surface area for receiving said optical output from across said substantially transparent media.

10. The method for forming an interface circuit for in an active antenna assembly used in vehicular satellite based communication, navigation or entertainment systems of claim 9, wherein the optical source is supplied from a light source selected from the group consisting of LEDs, LDs, lasers, infrared, or visible light sources and is configured so as to be used in a vehicular communications system chosen from the group of applications consisting of SDARS, GPS, or cellular communications.

11. The method for forming the interface circuit for in an active antenna assembly used in vehicular satellite based communication, navigation or entertainment systems of claim 10, wherein said receiving surface area for receiving said optical output is supplied as a solar cell array selected from the group consisting of conventional silicon solar cell arrays, high efficiency solar cell arrays, and GaAs solar cell arrays, and is situated in substantial alignment with said optical source.

12. The method for forming the interface circuit for in an active antenna assembly used in vehicular satellite based communication, navigation or entertainment systems of claim 11, wherein the optical source is supplied from an IR LD, and wherein said solar cell array is supplied from conventional silicon solar cell arrays, and is configured so as to be used in an SDARS application.

13. The method for forming the interface circuit for in an active antenna assembly used in vehicular satellite based communication, navigation or entertainment systems of claim 12, wherein said electrical input is supplied as DC power, and wherein said electrical to optical conversion module is formed so as to further include a DC biasing circuit for converting the electrical input.

14. The method for forming the interface circuit for in an active antenna assembly used in vehicular satellite based communication, navigation or entertainment systems of claim 13, further including installation of a substantially proximate set of substantially aligned, cooperative RF pads for bidirectionally transmitting RF signals between said first side of said substantially transparent medium, to said second side of said substantially transparent medium.

15. The method for forming the interface of claim 14, wherein both the solar cell array and the optical source may be formed according to customized shapes and sizes.

16. The method of forming the interface of claim 14 further including the step of installing an alignment module.
